(19) United States
(12) Patent Application Publication
(10) Pub. No.: US 2026/0028179 A1
(43) Pub. Date: Jan. 29, 2026

(54) LIFT HANDLE FOR RECEPTACLE

(71) Applicant: Findlay Machine & Tool, LLC, Findlay, OH (US)

(72) Inventors: Nickolas Reinhart, Sarasota, FL (US); Joe Klein, Findlay, OH (US); Ben Sayalith, Findlay, OH (US)

(21) Appl. No.: 19/280,723

(22) Filed: Jul. 25, 2025

Related U.S. Application Data
(60) Provisional application No. 63/675,562, filed on Jul. 25, 2024.

(51) Int. Cl. B65F 1/14; B65F 1/02

(52) U.S. Cl. CPC B65F 1/1452; B65F 1/02

(57) ABSTRACT

An improved lift handle for receptacles, designed to significantly enhance durability and user comfort, is provided. The lift handle includes a structural configuration with dual side supports, each comprising an outer and an inner wall joined together by a connecting wall. This design effectively distributes the load during use, minimizing common issues such as bending, deforming, and cracking. Additionally, the handle features an ergonomically designed hand grip with a U-shaped cross-section and apertures for fluid drainage, providing a comfortable and secure grip for the user. This lift handle can extend the service life of the receptacle and can promote more efficient use of the receptacle by reducing the need for frequent replacements and facilitating handling of the receptacle.

### CROSS-REFERENCE TO RELATED APPLICATIONS

This application claims the benefit of U.S. Provisional Application No. 63/675,562, filed on Jul. 25, 2024. The entire disclosure of the above application is incorporated herein by reference.

### FIELD

The present technology relates to receptacles and, more particularly, to structural enhancements of lift handles for receptacles.

### INTRODUCTION

This section provides background information related to the present disclosure which is not necessarily prior art.

Receptacles can be used to store and transport a variety of objects and can include one or more lift handles to facilitate lifting and moving the receptacle. Trash cans, a common intended use of such receptacles, are used for waste management in both residential and commercial settings and are frequently equipped with one or more lift handles to facilitate the movement and handling of the trash can, especially when it is full. However, the lift handles on certain trash cans can be prone to structural failure due to various stresses imposed during use. Issues include bending, deforming, and cracking of the lift handle, which can limit the functionality and lifespan of the trash can.

Design and material selection of the lift handles can influence their durability and usability. In certain trash cans, the handles are either integrated into a body of the trash can or attached in a manner that does not sufficiently distribute a load borne by the trash can. This can result in excessive stress at one or more attachment points and along the handle itself, leading to premature wear and cracking, including the detachment of the lift handle from the receptacle. Such failures can limit use of the trash can and in certain instances necessitate the replacement of the trash can.

Ergonomics of the lift handles is frequently overlooked in the design of certain trash cans. Lift handles that are not ergonomically designed can cause discomfort to a user, and can even limit use of the lift handle for the user, particularly when lifting heavy loads. The lack of ergonomic considerations can deter proper use and ultimately reduce the effectiveness of waste management practices.

Environmental factors such as exposure to various weather conditions and chemicals can also contribute to degradation of the lift handles. Materials used in some existing trash can handles may not be adequately resistant to such factors, leading to accelerated wear and failure. This issue is particularly pronounced in outdoor settings where trash cans can be exposed to a wide range of environmental stressors.

Accordingly, there is a continuing need for an improved design of lift handles for receptacles, including trash cans, that addresses the aforementioned issues. Desirably, such a design would enhance the structural integrity and durability of the lift handle, distribute loads more effectively, and incorporate ergonomic features to improve user comfort and ease of use. This would extend the service life of the receptacle, reduce the need for frequent replacements, and promote more efficient waste management practices.

### SUMMARY

In concordance with the instant disclosure, an improved design of a lift handle for a trash can has surprisingly been discovered. The present technology includes articles of manufacture, systems, and processes that relate to the structural reinforcement and ergonomic optimization of a lift handle for a trash can to enhance durability, user comfort, and overall functionality.

In certain embodiments, a lift handle for a receptacle is provided. The lift handle includes a first side support, a second side support, and a hand grip. The first side support can include a first outer wall, a first inner wall, and a first connecting wall, the first outer wall spaced apart from the first inner wall and joined to the first inner wall by the first connecting wall. The first outer wall and the first inner wall can be coupled to the receptacle. The second side support can include a second outer wall, a second inner wall, and a second connecting wall, the second outer wall spaced apart from the second inner wall and joined to the second inner wall by the second connecting wall. The second outer wall and the second inner wall can be coupled to the receptacle. The hand grip can be disposed between the first inner wall of the first side support and the second inner wall of the second side support.

In certain embodiments, a receptacle is provided. The receptacle can include a hollow body having a bottom panel and a sidewall extending upwardly from the bottom panel and terminating at a rim defining an open end of the hollow body. A lift handle can be formed on the sidewall of the receptacle. The lift handle can include a first side support and a second side support. The first side support can have a first outer wall and a first inner wall, the first outer wall spaced apart from the first inner wall, the first outer wall and the first inner wall coupled to the sidewall the of the hollow body. The second side support can have a second outer wall and a second inner wall, the second outer wall spaced apart from the second inner wall, the second outer wall and the second inner wall coupled to the sidewall the of the hollow body. A hand grip can be disposed between the first side support and the second side support of the handle.

In certain embodiments, a method of manufacturing a trash can is provided. The method can include the steps of forming a hollow body having a bottom panel and a sidewall extending upwardly from the bottom panel and terminating at a rim defining an open end and forming a lift handle on the sidewall. A first side support and a second side support for the lift handle can be formed. The first side support includes a first outer wall and a first inner wall, the first outer wall spaced apart from the first inner wall, the first outer wall and the first inner wall coupled to the sidewall the of the hollow body. The second side support includes a second outer wall and a second inner wall, the second outer wall spaced apart from the second inner wall, the second outer wall and the second inner wall coupled to the sidewall the of the hollow body. A hand grip can be formed between and connected to the first side support and the second side support.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a receptacle having a lift handle according to an embodiment of the present disclosure.

FIG. 2 is an enlarged top perspective view of the lift handle shown in FIG. 1.

FIG. 3 is an enlarged bottom perspective view of the lift handle shown in FIG. 1.

FIG. 4 is a cross-sectional view of the lift handle shown in FIGS. 2 taken along section line 4-4.

FIG. 5 is a is a front elevational view thereof.

FIG. 6 is a left-side elevational view thereof.

FIG. 7 is a top plan view thereof.

FIG. 8 is a bottom plan view thereof.

FIG. 9 is a flowchart illustrating a method of manufacturing the lift handle for a receptacle, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the structural integrity and ergonomic design of lift handles on receptacles. It should be understood that the lift handles can be used with or integrated into various types of receptacles including trash cans. The term “trash can” simply refers to a common intended use of such receptacles, however, the receptable can be used for many other purposes and functions. By addressing the common issues of bending, deforming, and cracking that plague conventional receptacle handles, this technology enhances the durability and usability of receptacles. Additionally, the lift handle incorporates ergonomic features that reduce the risk of discomfort or injury when using the receptacle. This can not only extend the service life of the trash cans but also promotes more effective and user-friendly receptacle handling solutions.

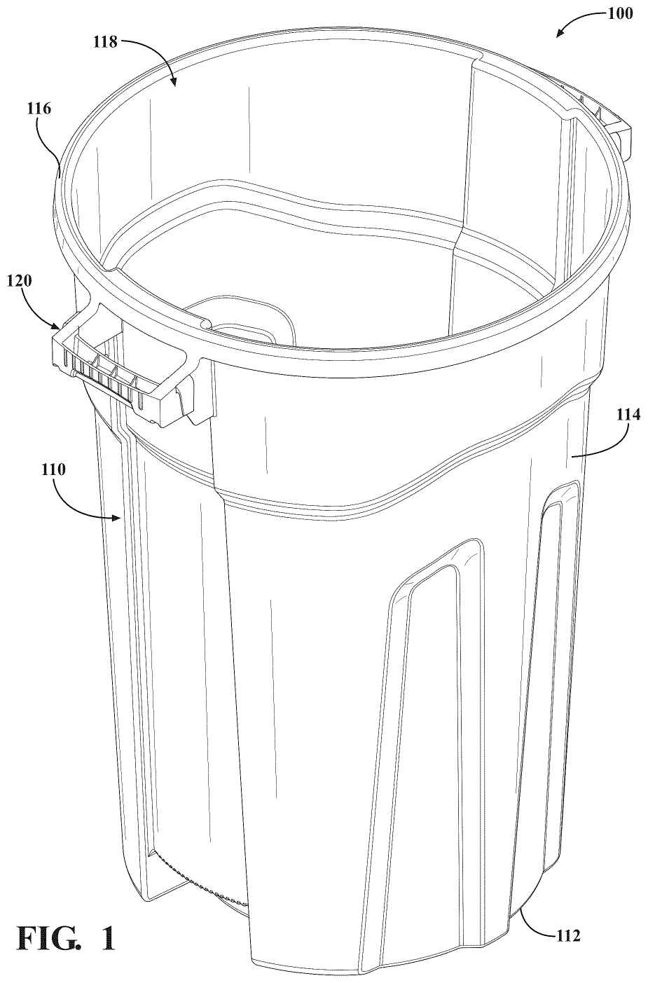

With reference now to FIG. 1, an embodiment of a receptacle 100 including a lift handle 120 designed to enhance user comfort and durability, is shown. In the illustrated embodiment, the lift handle 120 is shown as part of a “trash can.” It should be understood that the lift handle 120 can be used with or integrated into various types of receptacles, including trash cans. The term “trash can” refers to a common intended use of such receptacles; however, the receptacle 100 can be used for many other purposes and functions and be formed to having many different shapes and configurations. The receptacle 100 includes a hollow body 110 that serves as a container for waste, debris, and/or other items. The hollow body 110 can be constructed from materials such as plastic, metal, or any suitable composite that provides durability and resistance to environmental factors. Furthermore, manufacturing process such as injection molding, 3-D printing, metal stamping and/or forming, and other suitable manufacturing process can be utilized to form the receptacle 100.

The hollow body 110 of the receptacle 100 can include a bottom panel 112 and a sidewall 114. The bottom panel 112 can form the base of the receptacle 100, supporting the contents within. The sidewall 114 can extend upwardly from the periphery of the bottom panel 112 and terminate at a rim 116, which defines an open end 118 of the receptacle 100. The sidewall 114 can be configured in various shapes and cross-sections, and can include various additional features to enhance aspects of the receptacle 100, including rigidity, stability, stacking with other receptacles 100, and the use thereof. One or more lift handles 120 can be formed on the sidewall 114 of the receptacle 100. The lift handle 120 can facilitate the manual handling of the receptacle 100, making it easier to lift, move, or empty the contents of the receptacle 100. In this way, the lift handle 120 enhances the functionality of the receptacle 100.

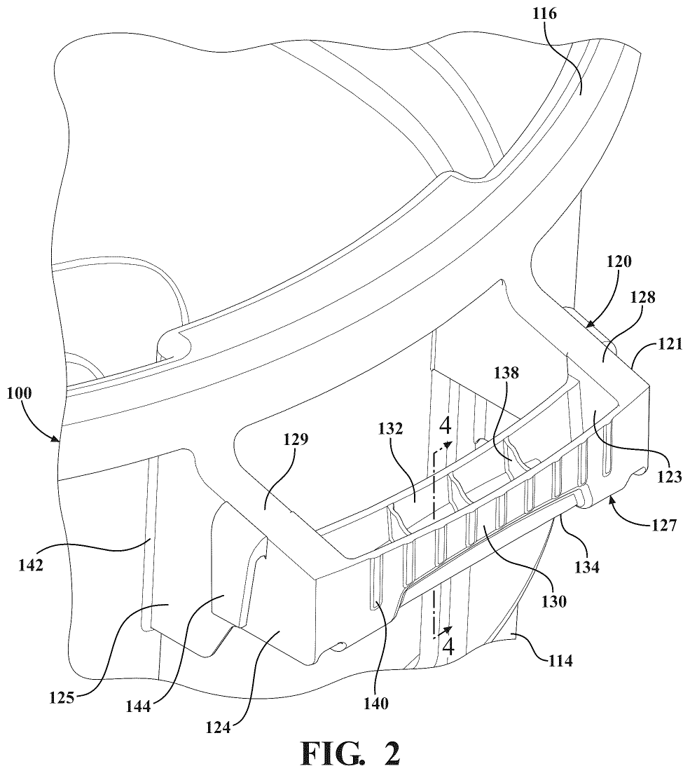

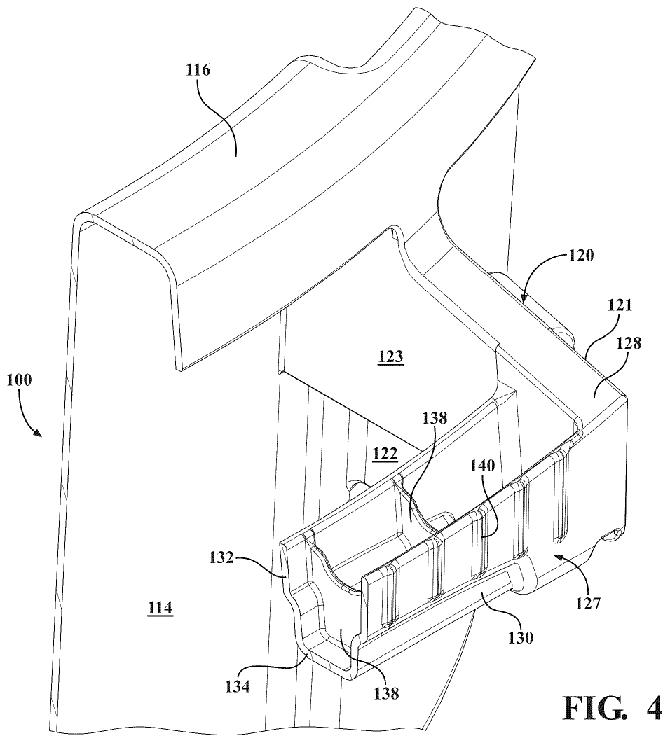

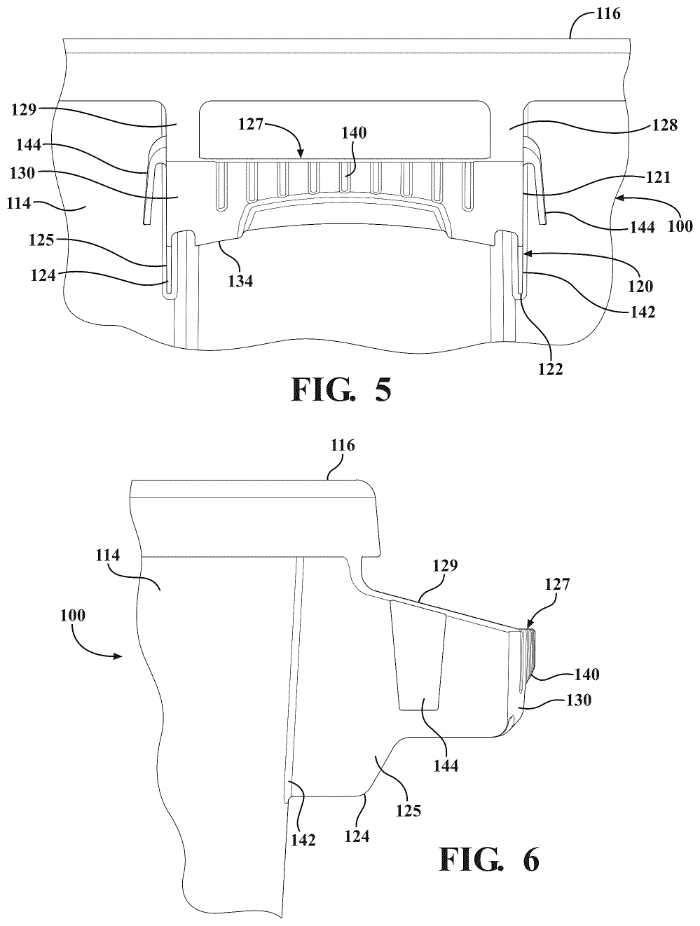

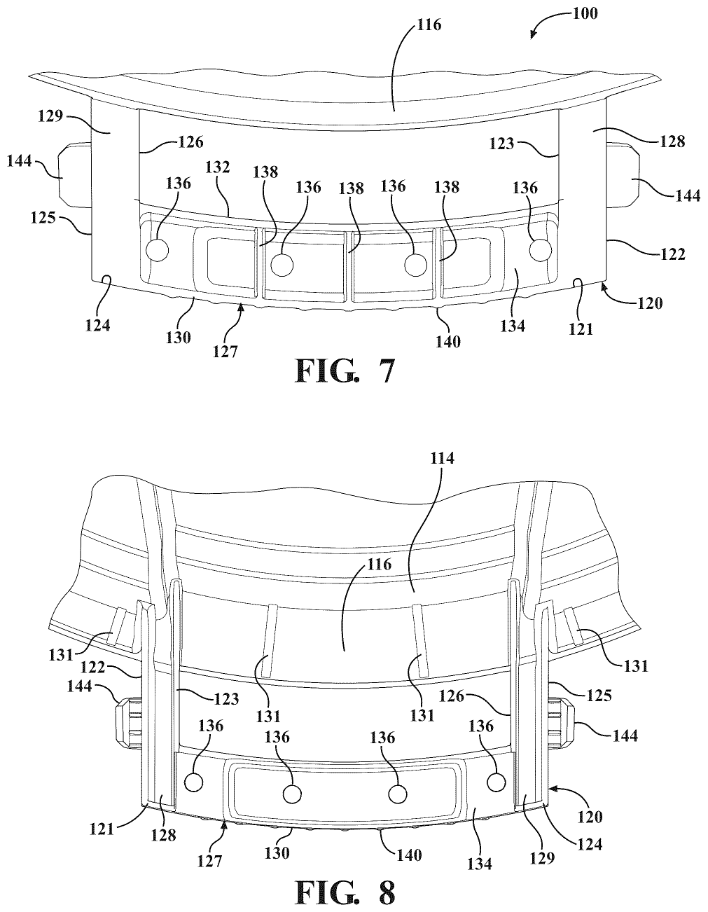

With reference to FIGS. 2-8, the lift handle 120 can include various aspects. The lift handle 120 can include a first side support 121 and a second side support 124 spaced apart from the first side support 121. The side supports 121, 124 can extend outwardly from the sidewall 114. The first side support 121 of the lift handle 120 can include a first outer wall 122 and a first inner wall 123, the first outer wall 122 and the first inner wall 123 extending outwardly from the sidewall 114 of the receptacle 100. The second side support 124 of the lift handle 120 can include a second outer wall 125 and a second inner wall 126, the second outer wall 125 and the second inner wall 126 extending outwardly from the sidewall 114 of the receptacle 100. The outer walls 122, 125 and inner walls 123, 126 are spaced apart, creating a gap therebetween. It should be understood that gap between the outer walls 122, 125 and inner walls 123, 126 can include reinforcing materials and/or structural elements or be left open to reduce the weight of the receptacle 100.

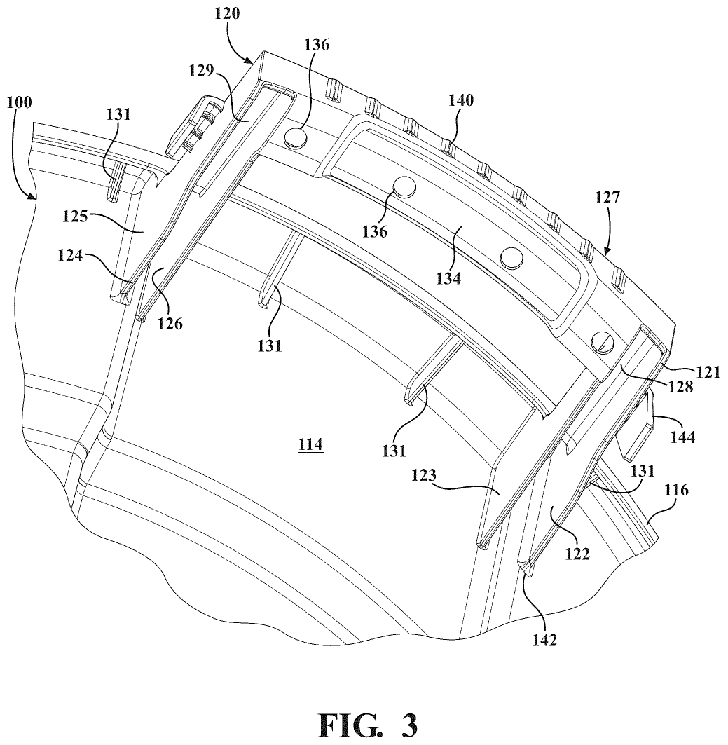

A first connecting wall 128 can be provided that joins the first outer wall 122 and the first inner wall 123 of the first side support 121, and a second connecting wall 129 can be provided that joins the second outer wall 125 and the second inner wall 126 of the second side support 124. In the illustrated embodiment, the first connecting wall 128 and the second connecting wall 129 can be join the upper ends of the respective outer walls 122, 125 and inner walls 123, 126. One or more of the outer walls 122, 125, the inner walls 123, 126, and the connecting walls 128, 129 can be coupled to the rim 116. Furthermore, as shown in FIG. 3, a rib 131 can be formed in the receptacle 100 under the rim 116 adjacent the lift handle 120 to reinforce the rim 116 and/or the lift handle 120.

The outer walls 122, 125 and inner walls 123, 126 of the side supports 121, 124 can be coupled to the sidewall 114 of the hollow body 110. A reinforcing member 142, such as a radiused transition, can be provided between the outer walls 122, 125 and inner walls 123, 126 of the side supports 121, 124 and the sidewall 114 to strengthen the coupling of the outer walls 122, 125 and inner walls 123, 126 of the side supports 121, 124 to the sidewall 114.

A hand grip 127 can be disposed between the first side support 121 and the second side support 124. The hand grip 127 can include an outer facing wall 130, an inner facing wall 132, and a bottom wall 134. The outer facing wall 130, the inner facing wall 132, and the bottom wall 134 can form a generally U-shaped cross-section of the hand grip 127, which can provide ergonomically shape designed to fit comfortably in the hand of a user. It should be understood the transition between the outer facing wall 130 and the bottom wall 134 as well as the inner facing wall 132 and the bottom wall 134 can include a radius, chamfered, angled segments, and/or recessed areas to facilitate a user to comfortably engaging the handle with a hand.

The outer facing wall 130 of the hand grip 127 may be coupled to the outer walls 122, 125 of the first and second side supports 121, 124. Additionally, the outer facing wall 130 of the hand grip 127 may be coupled to the inner walls 123, 126 of the first and second side supports 121, 124. The inner facing wall 132 and the bottom wall 134 of the hand grip 127 may be coupled to the inner walls 123, 126 of the first and second side supports 121, 124. This configuration can facilitate a distribution of a load applied to the lift handle 120 to a greater area of the sidewall 114 to minimize stress at locations where the lift handle 120 is coupled to the sidewall 114, thus enhancing the overall durability of the lift handle 120.

The bottom wall 134 of the hand grip 127 may include apertures 136. These apertures 136 may provide a path for fluids and other debris to pass through, preventing accumulation of such fluids and debris within U-shaped cavity of the hand grip 127 and helping to maintain maintaining cleanliness and hygiene. The hand grip 127 can include a rib 138 formed within the generally U-shaped cross-section cavity of the hand grip 127. The rib 138 can be coupled to at least two of the outer facing wall 130, the inner facing wall 132, and the bottom wall 134 of the hand grip 127 to reinforce and enhance the overall durability of the lift handle 120. In the illustrated embodiment three of the ribs 138 are provided; however, it should be understood that fewer or more than three of the ribs 138 can be provided to provide a desired strength to the lift handle 120 and as needed as the dimensions of the lift handle 120 are scaled up and down as may be needed or desired for receptacles of different size.

The hand grip 127 may include includes a non-slip feature 140 to enhance the grip on the user on the hand grip 127. The non-slip feature 140 can include a protrusion, a valley, a recessed area, a texture, or the like formed on a surface of the hand grip 127 configured to contact a hand of the user. It should be understood that the non-slip feature 140 can be formed on one or more of the outer facing wall 130, the inner facing wall 132, and the bottom wall 134 of the hand grip 127. Furthermore, the bottom wall 134 of the hand grip 127 can be curved to position a center portion of the bottom wall 134 closer to the rim 116 of the receptacle 100 than an end portion of the bottom wall 134 where a height of the outer facing wall 130 and the inner facing wall 132 are greater at the ends thereof as compared to the height of the center portion, the curvature of the bottom wall 134 enhancing ergonomic features of the lift handle 120.

In certain embodiments, the lift handle 120 can include a cinch 144 formed on an outer facing surface of the first outer wall 122 and the second outer wall 125 of the side supports 121, 124. In the illustrated embodiment, the cinch 144 is provided on each of the first outer wall 122 and the second outer wall 125. It should be understood that the cinch 144 can be formed on just one of the first outer wall 122 and the second outer wall 125, as desired. The cinch 144 can be provided to receive a portion of a bag and/or liner (not shown) that can be received in the hollow body 110 of the receptacle 100 where an open end of the liner can wrap the rim 116 and a portion of an upper edge of the liner can be received in the cinch 144 to facilitate maintaining the liner in a desired position with respect to the hollow body of the receptacle 100.

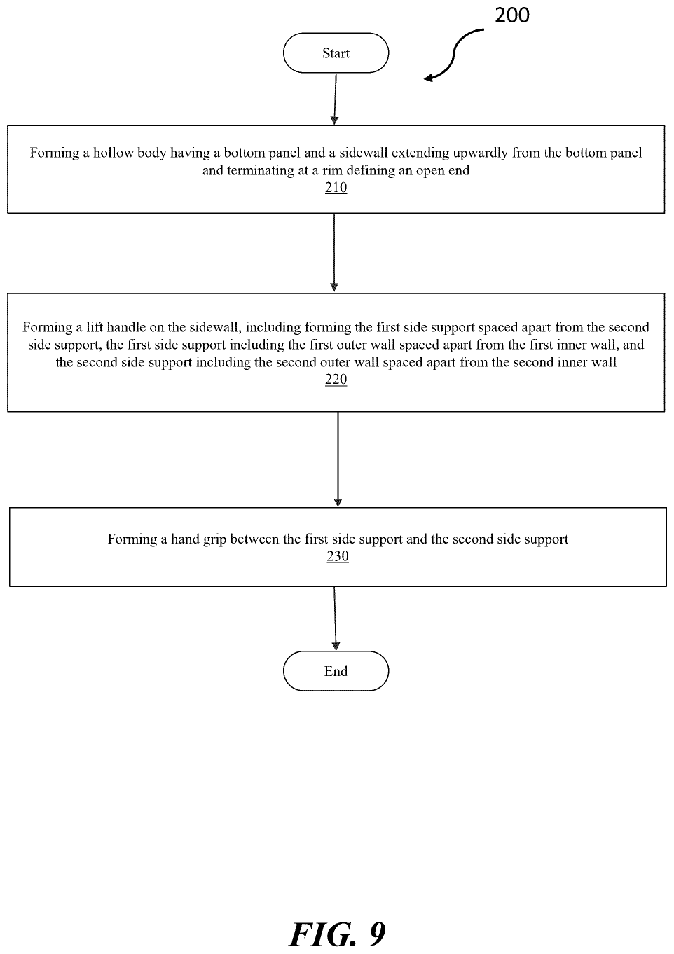

A method of manufacturing the receptacle 100 is shown in FIG. 9. The method 200 can include a step 210 of forming the hollow body 110 with the bottom panel 112 and the sidewall 114. A step 220 in the method 200 can involve forming the lift handle 120 on the sidewall 114. This step 220 can include forming the first side support 121 spaced apart from the second side support 124, the first side support 121 including the first outer wall 122 spaced apart from the first inner wall 123, and the second side support 124 including the second outer wall 125 spaced apart from the second inner wall 126. Where the lift handle 120 is integrated into the receptacle 100, such as where the receptacle 100 and associated features are formed by injection molding. It should be understood that the steps 210, 220, 230 can occur contemporaneously or substantially contemporaneously depending on the design of the mold for forming the receptacle 100.

Additional steps in the method 200 can include forming the hand grip 127 between the first side support 121 and the second side support 124. This step 230 can involve creating the U-shaped cross-section of the hand grip 127 having the outer facing wall 130, the inner facing wall 132, and the bottom wall 134. The outer facing wall 130 of the hand grip 127 can be coupled to the outer walls 122, 125 and/or the inner walls 123, 126 of the first and second side supports 121, 124. The inner facing wall 132 and the bottom wall 134 of the hand grip 127 can be coupled to the inner walls 123, 126 of the first and second side supports 121, 124.

The method 200 can also include forming one of the apertures 136 in the bottom wall 134 of the hand grip 127 and the non-slip feature 140 in the outer facing wall 130 of the hand grip 127.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A lift handle for a receptacle, the lift handle comprising:
a first side support including a first outer wall, a first inner wall, and a first connecting wall, the first outer wall spaced apart from the first inner wall and joined to the first inner wall by the first connecting wall, the first outer wall and the first inner wall coupled to the receptacle,
a second side support including a second outer wall, a second inner wall, and a second connecting wall, the second outer wall spaced apart from the second inner wall and joined to the second inner wall by the second connecting wall, the second outer wall and the second inner wall coupled to the receptacle, and
a hand grip disposed between the first inner wall of the first side support and the second inner wall of the second side support.

2. The lift handle of claim 1, wherein the hand grip includes an outer facing wall, an inner facing wall, and a bottom wall forming a generally U-shaped cross-section.

3. The lift handle of claim 2, wherein the inner facing wall of the hand grip includes a first end and a second end, the first end coupled to the first inner wall of the first side support and the second end coupled to the second inner wall of the second side support.

4. The lift handle of claim 2, wherein the bottom wall of the hand grip includes a first end and a second end, the first end coupled to the first inner wall of the first side support and the second end coupled to the second inner wall of the second side support.

5. The lift handle of claim 2, wherein the bottom wall of the hand grip includes an aperture formed therethrough.

6. The lift handle of claim 2, wherein the outer facing wall of the hand grip includes a non-slip feature.

7. The lift handle of claim 2, wherein the hand grip includes a rib disposed within the generally U-shaped cross-section and joined to at least two of the outer facing wall, the inner facing wall, and the bottom wall.

8. A receptacle comprising:
a hollow body having a bottom panel and a sidewall extending upwardly from the bottom panel and terminating at a rim defining an open end; and
a lift handle formed on the sidewall, the lift handle including
a first side support including a first outer wall and a first inner wall, the first outer wall spaced apart from the first inner wall, the first outer wall and the first inner wall coupled to the sidewall of the hollow body,
a second side support including a second outer wall and a second inner wall, the second outer wall spaced apart from the second inner wall, the second outer wall and the second inner wall coupled to the sidewall of the hollow body, and
a hand grip disposed between the first side support and the second side support.

9. The receptacle of claim 8, wherein the lift handle is coupled to the rim of the hollow body.

10. The receptacle of claim 8, wherein the rim includes a reinforcing rib adjacent the lift handle.

11. The receptacle of claim 8, wherein the lift handle includes a first connecting wall joining the first outer wall and the first inner wall of the first side support and a second connecting wall joining the second outer wall and the second inner wall of the second side support.

12. The receptacle of claim 11, wherein at least one of the first connecting wall, the first outer wall, the first inner wall, the second connecting wall, the second outer wall, and the second inner wall of the lift handle is coupled to the rim of the hollow body.

13. The receptacle of claim 8, wherein the hand grip includes an outer facing wall, an inner facing wall, and a bottom wall forming a generally U-shaped cross-section.

14. The receptacle of claim 13, wherein the inner facing wall of the hand grip is coupled to the first outer wall of the first side support and the second outer wall of the second side support.

15. The receptacle of claim 13, wherein the bottom wall of the hand grip is coupled to the first outer wall of the first side support and the second outer wall of the second side support.

16. The receptacle of claim 13, wherein the hand grip includes a rib formed within the generally U-shaped cross-section of the hand grip, the rib coupled to at least two of the outer facing wall, the inner facing wall, and the bottom wall of the hand grip.

17. The receptacle of claim 13, wherein the hand grip includes an aperture formed in the bottom wall of the hand grip to provide a path for fluids and other debris to pass through.

18. The receptacle of claim 13, wherein the outer facing wall of the hand grip includes a non-slip feature.

19. The receptacle of claim 13, wherein at least one of the first outer wall of the first side support and the second outer wall of the second side support includes a cinch formed thereon.

20. A method of manufacturing a receptacle, the method comprising:
forming a hollow body having a bottom panel and a sidewall extending upwardly from the bottom panel and terminating at a rim defining an open end; and
forming a lift handle on the sidewall, the lift handle including,
a first side support including a first outer wall and a first inner wall, the first outer wall spaced apart from the first inner wall, the first outer wall and the first inner wall coupled to the sidewall of the hollow body,
a second side support including a second outer wall and a second inner wall, the second outer wall spaced apart from the second inner wall, the second outer wall and the second inner wall coupled to the sidewall of the hollow body, and
a hand grip formed between and connected to the first side support and the second side support.
